(19) United States
(12) Patent Application Publication
(10) Pub. No.: US 2015/0308544 A1
(43) Pub. Date: Oct. 29, 2015

(54) CONTINUOUSLY VARIABLE TRANSMISSION MECHANISM DRIVEN BY SELF-ACTUATING CONTROL OF RING GEAR

(71) Applicant: Minoru NAKAGAWA, Yokohama-shi, Kanagawa (JP)

(72) Inventor: Minoru NAKAGAWA, Yokohama-shi (JP)

(21) Appl. No.: 14/443,103

(22) PCT Filed: Jul. 22, 2013
(86) PCT No.: PCT/JP2013/070671

§ 371 Date: May 15, 2015

(30) Foreign Application Priority Data
Nov. 17, 2012 (JP) 2012-266718

(51) Int. Cl. F16H 3/72

(52) U.S. Cl. CPC F16H 3/72

(57) ABSTRACT

Continuously variable transmission mechanism wherein a push arm provided with a power roller (9) and a drive roller (8) being supported by a support frame (4) which supports a planet gear (11) that mesh with a sun gear (12),
a ring type of an outer circumferential support frame (5) supporting a cam arm (7a,b,c) with a cam mount on the above and below thereof,
an outer cam (3),
a control gear (6) being provided around an outer circumference of a drive arm (7a,b,c) with a claw supported by a central shaft,
a ring gear (10) which a ratchet is minced, and a planetary gear constitution, instead of a planet gear control driving using a planetary gear structure, and,
wherein the cam arm (2) is pushed by the control gear (6) to attain a reciprocating drive the push arm (1) and further the drive arm (7), via an one-way mechanism a drive to an opposite direction for the input is rendered to a ring gear (10) rotating in the same direction for the input to add a power of a rotation drive to an opposite direction for the input to the planetary gear (11) to add a power of a rotation in the same direction for the input to the sun gear (12) at the output side to carry out the drive and control the ring gear by a power produced by the input rotation.

### TECHNICAL FIELD

The present invention relates to a continuously variable transmission mechanism among the power transmissions of a planetary gear.

### BACKGROUND ART

In the rotation transmission system practically used according to the planetary gear arrangement, a continuously variable transmission is practically used by a stepwise shift transmission method by the lock-up wherein each gear ratio is fixed.

The rotation transmission system practically used according to the planetary gear arrangement is an arrangement wherein each gear ratio is fixed, and therefore, it has been practically insufficient to obtain a continuously variable transmission.

However, although the “planetary gear self-actuated control drive type continuously variable transmission mechanism” which have been filed as Japanese Patent Application 2012-138212 making it possible to carry out a continuously variable transmission according to the planetary gear arrangement wherein a gear ratio is fixed, makes it possible to realize a self-operated control drive means according to a planetary gear, but there is a limit to an integrative such as the size of the planetary gear diameter having an influence on the transmission ratio, and therefore, there is a disadvantage that it is impossible to obtain a high gear ratio.

There is a problem that it is impossible to keep a high gear ratio in the above self-operated control drive constitution to a planetary gear.

### PRIOR ART LITERATURE

### Patent Literature

JP 2012-138212

### Non Patent Literature

### DISCLOSURE OF THE INVENTION

### Problems to be Resolved by the Invention

Although it is possible to obtain a variable speed drive of a sun gear though an output on one-on-one level with input according to a direct control drive of a planet gear of the “planetary gear self-actuated control drive type continuously variable transmission mechanism” which have been filed as Japanese Patent Application 2012-138212, the problem to be solved is that it is impossible to obtain a gear ratio from an output on one-on-one level with input to further high gear ratio in a set of planetary gear constitution.

### Means of Solving the Problems

The continuously variable transmission mechanism by a ring gear self-actuated control drive according to the present invention is most mainly characterized in that it comprises:
a direct control drive construction of the planetary gear via a load at the output side and the input of the “planetary gear self-actuated control drive type continuously variable transmission mechanism” for example, which have been filed as Japanese Patent Application 2012-138212,
wherein a ring gear according to a direct control drive construction means via a load at the output side and the input attains continuously variable transmission of a sun gear at the output side.

### Effect of Invention

A ring gear self-actuated control drive type of continuously variable transmission mechanism according to the present invention is characterized in that it comprises:
a planetary gear construction which is capable of offsetting for the load of the sun gear at the output side via the input which has a smaller diameter of the planetary gear than that of the “planetary gear self-actuated control drive type continuously variable transmission mechanism” which have been filed as Japanese Patent Application 2012-138212 as previously, and has an advantage that it is possible to attain easily a gear ratio from an output on one-on-one level with input to further high gear ratio in a set of planetary gear constitution to provide a compact size of the continuously variable transmission.

### BRIEF DESCRIPTION OF THE DRAWINGS

FIG. 1 gives a diagram showing a constitution and an implementation methods for a ring gear self-actuated control drive type of continuously variable transmission mechanism (partially shown). (Example 1)

FIG. 2 is a diagram showing a drive on one-on-one level with input of a ring gear self-actuated control drive type of continuously variable transmission mechanism in a form that a drive position of each member is divided within A shown in the figure, that is the input angle (partially shown).

FIG. 3 is a diagram showing a high geared drive of a ring gear self-actuated control drive type of continuously variable transmission mechanism in a form that a drive position of each member is divided within A shown in the figure, that is the input angle (partially shown).

### MODE FOR CARRYING OUT THE INVENTION

An object of the continuously variable transmission by a set of planetary gear configuration was attained by carrying out an universal decelerating drive in a form that a drive of a ring gear from a drive on one-on-one level with input to a drive later than the input via a load of the output and the input, and was attained by carrying out a self-actuated control drive to a stop area to attain a object for obtaining a high continuously variable transmission drive of the sun gear at the output side via the ring gear self-actuated drive by a minimum member.

### Example 1

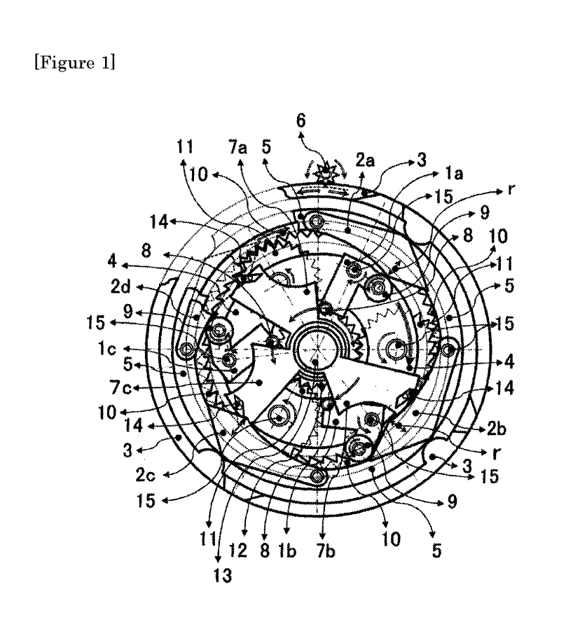

FIG. 1 gives a diagram showing a high geared region by the main constructional element of one Example of a ring gear self-actuated control drive type of continuously variable transmission mechanism according to the present invention (partially shown as a matter of convenience), and it is shown that 1a,b,c is a push arm, 2a,b,c is a cam arm with a cam mount on the above and below thereof, 3 is an outer cam, 4 is a support frame of the input side, 5 is an outer circumferential support frame, 6 is a control gear, 7a,b,c is a drive arm, 8 is a drive roller, 9 is a power roller, 10 is a ring gear with ratchet, 11 is a planetary gear, 12 is a sun gear of the output side, 13 is a central shaft, 14 is a claw, 15 is a shaft, A is an input angle up to a cam mountain of the cam arm, r is an amount of lift and an arrow is a drive direction of each parts.

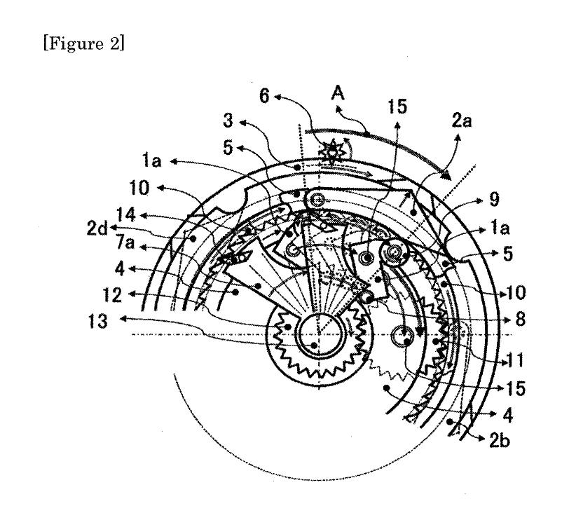

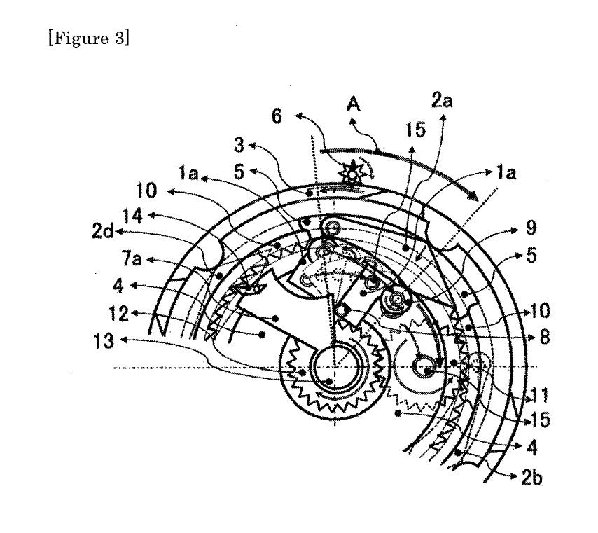

FIG. 2 is a diagram showing a drive image of each member up to a cam mountain of the cam arm within an input angle A in a drive on one-on-one level with input in a low geared region, and FIG. 3 is a diagram showing those in a high geared region.

A planetary gear constitution is a constitution that a shaft of a push arm (1a,b,c) with a power roller (9) and a drive roller (8) and a shaft of a planetary gear (11) are supported by a support frame (4), a drive arm (7a,b,c) with claw (14) is supported by a central shaft, a reciprocating drive of a drive arm (7a,b,c) is carried out by a reciprocating drive of a drive roller (8) via a reciprocating drive of a power roller (9) of a push arm (1a,b,c) and a claw (14) of a drive arm (7a,b,c) is meshed with ratchet of a ring gear (10), and in a circumference of the planetary gear, a cam arm with a cam mount on the above and below thereof (2a,b,c,d) is supported to an outer circumferential support frame (5), an outer cam (3) for moving the cam arm (2a,b,c,d) up and down and a control gear (6) are provided.

In FIG. 2 showing that a drive position of each member up to a cam mountain of a cam arm is divided within A, that is the input angle shown in the figure, an input shown by an arrow integrated with a planetary gear (11) of a support frame (4) makes it possible to drive a ring gear (1) in a direction of the input by a load of a meshed sun gear (12) of the output via a planetary gear (11) to attain a drive in a direction of the input for a central shaft (13) as a shaft of a drive arm (7a,b,c) via a claw (14) meshed with ratchet of a ring gear (10), and thereby the drive arm (7a) pushing a drive roller (8) and to allow a power roller (9) to push an internal surface of an outer circumference support frame (5) via a point of support of a shaft (15) of a push arm (1a) with the drive arm (8). In a form that a rotation power pushed out to a ring gear by a load of the output in a direction of the input is stopped on an internal surface of an outer circumference support frame (5), a drive on one-on-one level integrated with input is directly carried out to carry out a revolution drive on one-on-one level integrated with input by stopping a rotation of the meshed planetary gear (11) to carry out a revolution drive of the meshed sun gear (12) of the output side together with the planetary gear (11) which a rotation stops, to be able to obtain a low geared region by a stable drive of a sun gear (12) on one-on-one level with input.

In a push arm (1a) side of FIG. 1, a cam arm (2a,b,c,d) is pushed to each position of an amount of lift shown in r by the rotary drive of the control gear (6) in a direction of an arrow, a power roller (9) continuing to push and rotate on an internal surface of an outer circumference support frame (5) exists in a maximum position of a cam mountain of the cam arm (2a) when passing, and to push a power roller (9) via a shaft (15) of a push arm (1a) as a point of support to attain a drive of a drive roller (8) by the principle of leverage in a opposite direction of the input. And then a drive arm (7a) in a drive on one-on-one level with the same speed as input via a load of the output for a central shaft (13) as a point of support is rolled back to an opposite direction of input, to attain a maximum state of a decelerating drive comparing with the input in an opposite direction via one way mechanism of a ring gear (10) with ratchet together with the provided claw (14).

In a similar way, in a push arm (1b) side of FIG. 1, a power roller (9) arrives at a position passing a cam mountain of a cam arm (2a) to allow a reciprocating motion getting back to the circumference direction via a shaft (15) of the push arm (1b) as a point of support according to a return spring (it is omitted in Figure), it is possible to get back a power roller (9) and a drive roller (8) in a circumference direction as a central of a shaft (15) of a push arm (1b) and it is also possible to get back a drive arm (7b) according to a return spring (it is omitted in Figure) and a one way mechanism via a central shaft (13) as a shaft.

In a similar way, in a push arm (1c) side of FIG. 1, at a position that a power roller (9) moves into action to pass a cam mountain of a cam arm (2d), a power roller is pushed to a direction of a central shaft wherein a shaft (15) of a push arm (1c) is as a point of support, and a drive roller (8) moves into action to drive by the principle of leverage wherein a shaft of a push arm (1c) is as a point of support, and thereby pushing in an opposite direction of the input wherein a central shaft (13) of a drive arm (7c) is as a shaft. A condition is shown that a decelerating drive moves into action to carry out via one way mechanism of a ring gear (10) with ratchet and a provided claw (14), it is possible to obtain a decelerating drive of a ring gear (10) by a serious of each member.

A drive of a planetary gear (11) integrated with the input of a meshed support frame (4) via a directly and decelerating drive compering with the input of an universal ring gear (10) by means of the input makes it possible to operate a rotation drive of the planetary gear (11) forcibly and universally in an opposite direction of the input and thereby attaining a continuously variable transmission drive of the meshed sun gear of the output (12) universally.

In a high geared region showing a drive position of each member up to a cam mountain of a cam arm is divided within A shown in the figure, that is the input angle, a power roller (9) rotating in inside of an outer circumferential support frame (5) is pushed to the top of the cam mountain of the cam arm (2a) to drive a drive roller (8) wherein a shaft of a push arm (1b) is as a center, in a direction of the input in that case that a central shaft (13) of a drive arm (7a) is a shaft. The condition that a drive roller (8) continues to push the drive arm (7a) makes it possible to drive up to a condition that the drive arm (7a) stops to mesh claw (14) of a stop condition of the drive arm (7a) with a ratchet of a ring gear (10) wherein a drive power in a direction of input operates via a load of the output constantly, and thereby obtaining a stop of driving a ring gear (10) in a direction of input.

A revolution drive of the planetary gear (11) integrated with a rotation of the input makes it possible to profile a surface of gear of a ring gear (10) which is in a condition of stopping a drive, to maximize a rotation drive in an opposite direction of the input forcibly. An forcibly addition of a drive of the meshed sun gear (12) at output side in a direction of the input makes it possible to universally obtain a continuously variable transmission drive from an output on one-on-one level with input to a high change gear ratio.

Although FIG. 1 shows a basic drive constitution according to the present invention, it is possible to change a fixation of a chassis of the outer cam (3), a fixation of a chassis of the outer circumferential support frame (5), and a direct rotary drive of the outer cam (3). And it is possible to change a rotary drive means or a fixation of a chassis for the control gear (6), the outer cam (3) and the outer circumferential support frame (5) in other constitutions of pushing the cam arm (2a,b,c,d) stably. On account of the stability of the change to a high geared region or a low geared region by these rotary drive, a rotation or a drive of reciprocating of the power roller (9) during a drive between input and output at each change position, it is possible to change it instantly with low resistance under the conditions during rotation of the input or during stop of the input. It is possible to overdrive by attaching a function of locking up the rotation of the ring gear temporarily. It is also possible to adopt a rotary drive electrically or mechanically by means of a numerical value of the rotation at the output side of the control gear (6) etc., to attain a full automatic continuously variable transmission mechanism. It is possible to change a position of the input and output by adding some members or changing a position since it is a constitution of the planetary gear.

It is possible to attain a deceleration drive at the input side for driving the continuously variable transmission according to the present constitution. In a similar way, each planetary gear can be parent-child planetary gear. A drive arm (7a,b,c) can be meshed with a push arm (1a,b,c) by carving a gear. It is possible to attain a double speed drive by incorporating the other function by the principle of leverage to the push arm. It is possible to insert and integrated these constitutions spirally into a tubular support frame to improve a gear ratio between the input and output to take a number of times or a speed of return of the push arm (1a,b,c) into account. It is possible to improve a variable transmission ratio by enlarging a gear ratio of each planetary gear (11) or by reducing a diameter of gear of the meshed sun gear (12). A several sort of combinations such as an integration with other one way mechanism are thought. According to each application, in particular, it is possible to change a shape of cam of each cam arm, a structure at a contact site between a drive roller (8) and a drive arm (7a,b,c), a size, a shape, the number, an angle for adopting, a position of each member, a member for these each member, an integration of on way mechanism at other position ob the member, a fixing of a bearing, a return spring etc.

### INDUSTRIAL APPLICABILITY

It is possible to apply it as a new another application such as a variable transmission of a bicycle or the like since it is a simple and small continuously variable transmission making it possible to obtain a high transmission ratio according to a set of planetary gear constitution by one central shaft configuration.

### DESCRIPTION OF THE REFERENCE NUMERALS

1a,b,c a push arm with a power roller and a drive roller
2a,b,c a cam arm
3 an outer cam
4 a support frame (of the input side)
5 an outer circumferential support frame
6 a control gear
7a,b,c a drive arm with claw
8 a drive roller
9 a power roller
10 a ring gear with ratchet
11 a planetary gear
12 a sun gear
13 a central shaft
14 a claw
15 a shaft
r an amount of lift
A an input angle

1. A ring gear self-actuated control drive type continuously variable transmission mechanism, wherein it comprises:
an outer circumferential support frame (5) supporting a cam arm (2a,b,c,d) with a cam mount on the above and below thereof,
an outer cam (3),
a control gear (6) around an outer circumference of a planetary gear which is comprised by
a support frame (4) supporting a push arm (1a,b,c) with a power roller (9) and a drive roller (8), and a planetary gear (11),
a ring gear (10) which a ratchet is minced,
a sun gear at the output side, and
a drive arm (7a,b,c) with a claw supported by a central shaft,
wherein a drive of the sun gear (12) at the output side on one-on-one level with an input which is made via an input of the support frame (4) and a load of the sun gear at the output side, by driving a planetary gear (11), a ring gear (10) and a drive arm (7a,b,c) with an one-way mechanism to drive a push arm (1a,b,c) by using a leverage through a drive roller (8) to push the power roller (9) on a surface of an inner wall of the outer circumferential support frame (5) to offset a load at the output side to obtain a revolution drive wherein the rotation of the planetary gear (11) is stopped through an drive on one-on-one level with the input of a ring gear,
a drive to add the rotation power in the input direction to the sun gear (12) at output side which is made by rotation driving of an outer cam (3) via a control gear (6) to push a cam arm (2a,b,c,d) to obtain a reciprocating drive of a push arm (1a,b,c) by using a leverage by each power roller passing the cam arm to be pushed and a reciprocating drive of a drive arm (7a,b,c) to add a later decelerating drive via an one-way mechanism than that of the input of a ring gear (10), and a rotation drive to an opposite direction for the input via a planetary gear (11) integrated with an input, are attained to universally carry out the direct control transmission of the ring gear (10) by oneself through the load at the output side and a rotation of the input.
